(19) United States
(12) Patent Application Publication
(10) Pub. No.: US 2021/0342418 A1
(43) Pub. Date: Nov. 4, 2021

(54) SYSTEMS AND METHODS FOR PROCESSING DATA TO IDENTIFY RELATIONAL CLUSTERS

(71) Applicant: EAB Global, Inc., Washington, DC (US)

(72) Inventors: Steven Mortimer, Arlington, VA (US); Phil Friesen, Ashburn, VA (US); Ben Wang, Washington, DC (US); Geoffrey Howe, Annandale, VA (US); Emily Ryan, Washington, DC (US)

(73) Assignee: EAB Global, Inc.

(21) Appl. No.: 17/320,905

(22) Filed: May 14, 2021

Related U.S. Application Data
(63) Continuation of application No. 13/889,012, filed on May 7, 2013, now abandoned.
(60) Provisional application No. 61/809,137, filed on Apr. 5, 2013.

(51) Int. Cl. G06F 17/18; G06F 16/28; G06N 5/04

(52) U.S. Cl. CPC G06F 17/18; G06N 5/04; G06F 16/285; G06F 16/288

(57) ABSTRACT

Embodiments of the present disclosure relate to systems and methods that may be employed for processing data to identify relational clusters, the method including receiving, using at least one processor, prior event data, the prior event data comprising a plurality of fields, the plurality of fields corresponding to a plurality of columns and a plurality of rows; determining, using the at least one processor, column field value correlations between the plurality of fields in the plurality of columns; and determining, using the at least one processor, a first column of the plurality of columns with a column field value correlation beyond a predetermined threshold with a second column of the plurality of columns.

### BACKGROUND

In today's competitive marketplace, successfully completing post-secondary higher education has become an invaluable asset to job seekers. However, students face many obstacles in their academic career that can prevent them from graduating on time, or, in some cases, even graduating at all. Students and academic institutions can benefit from identifying such obstacles early in the student's academic career in order to address such obstacles before they have a chance of derailing successful completion of a degree. It is with respect to this general environment that embodiments of the present disclosure have been contemplated.

### SUMMARY

Embodiments of the present disclosure relate to systems and methods that may be employed to generate predictive indicators that may be used to determine predictive estimates as to whether a student will succeed in a selected course or major. In embodiments, the predictive indicators may be generated based upon an analysis historical data from an institution. The analysis may determine factors that indicate whether a student will succeed in a given course or major. Upon identification, these factors may be synthesized into one or more predictive indicators. The predictive indicators may be compared against information about a current student to determine a predictive estimate regarding the likelihood of successful completion of a selected course. In further embodiments, predictive estimates may be used to generate alerts about the student's progress in completing a selected major. The alerts may be provided to a student or an administrator thereby allowing the application of a corrective action to promote the student's timely graduation.

In further embodiments, various user interfaces are disclosed that allow a user to generate queries for predictive estimates and view results from the queries. Generation of the user interfaces may be dependent on an identified type of user. For example, different user interfaces may be generated for students, advisers, and administrators.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The same number represents the same element or same type of element in all drawings.

FIG. 1 is an embodiment of a systematic overview 100 for providing predictive estimates related to an academic institution.

FIG. 2 is an embodiment of a method 200 for providing predictive estimates related to an academic institution.

FIG. 3 illustrates an exemplary generation of a prepared data set based on a historical data set.

FIG. 4 illustrates an exemplary synthesis of predictive indicators.

FIG. 5 illustrates an exemplary process for generating a predictive estimate.

FIG. 6 is an embodiment of a method 600 for dynamically evaluating student performance against predictive indicators in real time and providing predictive estimates.

FIG. 7 is an embodiment of a method 700 for dynamically predicting course difficulty based on current and historical data.

FIG. 8 is an embodiment of a method 800 for dynamically evaluating a predicted likelihood to complete any given major.

FIG. 9 is an embodiment of a method 900 for aggregating the predictive estimates at a program and institutional level.

FIG. 10 is an embodiment of a method 1000 for generating alerts based upon predictive analysis of a student's success.

FIG. 11 is an embodiment of a user interface 1100 for displaying an institutional analysis.

FIG. 12 is an embodiment of a user interface 1200 displaying an alternate view of an institutional analysis.

FIG. 13 is an embodiment of a user interface 1300 displaying a work list for an adviser.

FIG. 14 is an embodiment of a user interface 1400 displaying information about a student.

FIG. 15 is an embodiment of a user interface 1500 displaying a risk score analysis for a student.

FIG. 16 is an embodiment of a user interface 1600 displaying success tracking information for a student.

FIG. 17 is an embodiment of a user interface 1700 displaying an alternate view of course alerts for a student.

FIG. 18 is an embodiment of a user interface 1800 displaying a major matcher.

FIG. 19 is an embodiment of a user interface 1900 displaying an alternate view of a major matcher that provides course level detail for selected majors.

FIG. 20 illustrates one example of a suitable operating environment 2000 in which one or more of the present examples can be implemented.

FIG. 21 is an embodiment of a network 2100 in which the various systems and methods disclosed herein may operate.

### DETAILED DESCRIPTION

Embodiments of the present disclosure relate to systems and methods that may be used to aid educational institutions in improving the rate of degree completion for students by enabling active management of student progress across the entire lifecycle of the student's academic career. The embodiments disclosed herein may be used to serve students, advisers, and academic administrators by providing insights into at risk populations for identification, triage and remediation. In embodiments, the disclosed systems and methods may utilize past institution data to synthesize predictive indicators and academic milestones against a discrete pathway, such as, but not limited to, successfully passing a specific course of successful completion of a specific major. Embodiments disclosed herein may also provide a forecast of the likelihood of success or risk (by student, by major, by course, etc.) based on probability to succeed and/or complete as well as other factors. Among other benefits, the embodiments disclosed herein provide derived data driven insights that students, advisers, and administrators do not have readily available to them.

Embodiments disclosed herein may use models, such as, but not limited to, statistical models to analyze historical data at an institution to identify meaningful patterns with successful and not successful populations of students in each degree program. These models may be used to generate a definition of a core set of degree program milestones and risk factors that are shown to be highly correlated to the student's outcome in a chosen degree. Embodiments also may produce forward looking models that can help with academic planning and minimize risk proactively to allow an adviser to facilitate a discussion with students around course and major selection as early as in the first year. For both courses and majors, the models may provide a prediction on likelihood to be successful at the course and major levels for a specific student.

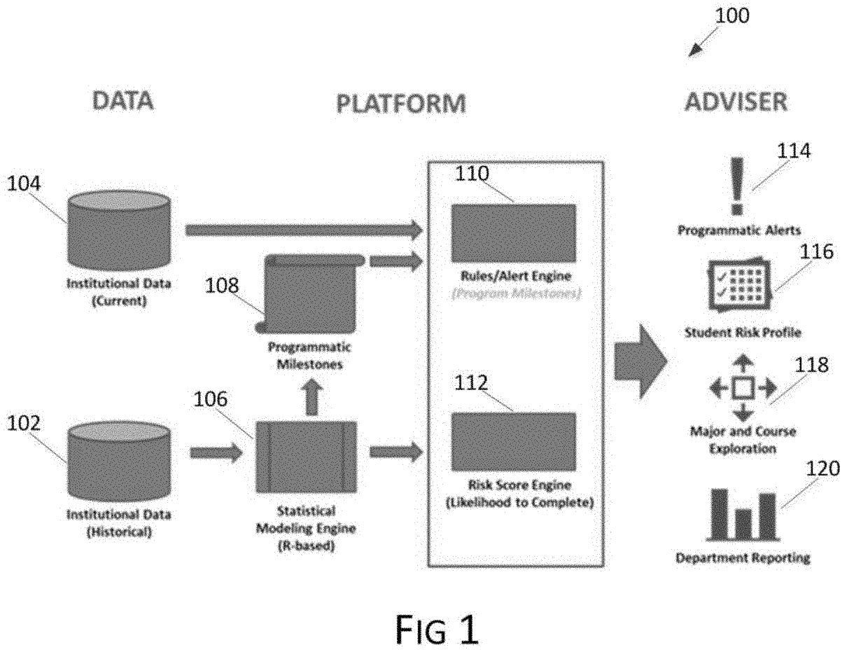

FIG. 1 is an embodiment of a systematic overview 100 for providing predictive estimates related to an academic institution. Systematic overview 100 illustrates different operational tiers that make up a system for providing predictive estimates about academic success for students. The first operational tier may be referred to as a data tier. The data tier may include historical and current institutional data. As will be described in further detail, the historical data may be used to identify predictive indicators related to a course or major while the current data may be evaluated against predictive indicators (e.g., from historical data) to generate predictive estimates for current students. The second operational tier may be referred to as a platform tier. The platform tier may include various devices and software modules that operate on the historical data to identify predictive indicators and then apply the predictive indicators to current data to generate predictive estimates. The third operational tier may be referred to as the adviser tier. The adviser tier may include various user interface that allows users to query and view predictive estimates. In an academic setting, the user interface may be customized for a particular type of user. For example, a first user interface may be presented to a student, a second user interface may be presented to an adviser, and a third user interface may be presented to an administrator, such as a provost. The different user interfaces may provide different query capabilities and access to different sets of current and/or historical data. For example, a student may be limited to access information about herself while an adviser may be limited to access information about the students assigned to her. An administrator, on the other hand, may have access to all of the institutional data available.

In embodiments, historical institutional data 102 may be provided as input to a statistical modeling engine to identify various predictive indicators. In embodiments, historical institutional data 102 may comprise grades that students received in courses over the years. In other embodiments, historical institutional data 102 may also include other types of information, such as the various clubs or teams individual students belong to, activities individual students participated in, awards or scholarships received by students, etc. While all of these types of data may be used to identify predictive indicators, for ease of discussion, this disclosure will described embodiments in which the historical institutional data includes the grades students received in particular classes. In addition to clarify the disclosure, academic institutions tend to track and retain grade information better than other types of student data. As such, grade information may be used to generate better predictive indicators due to the more comprehensive and reliable nature of the larger data set available for analysis.

A statistical modeling engine 106 may receive historical institutional data as an input to identify predictive indicators. Upon receiving the historical institutional data, the statistical modeling engine may apply various algorithms to infer or otherwise estimate missing data. For example, students do not take all of the classes available at an academic institution. However, various statistical algorithms may be applied to the historical intuitional data 102 to estimate grades that a student most likely would have received in classes they did not take as well as for other courses that have shown through the statistical modeling to have strong correlations to each other. Initial research has shown strong relationships outside of the immediate topic area. For example, the grades that a student received in the math classes she took may be averaged to estimate the grade the student would have received in the math classes she did not take. One of skill in the art will appreciate that this is only one way of inferring missing data and other types of algorithms may be applied without departing from the scope of the disclosure.

In embodiments, the statistical modeling engine 106 creates a prepared data set out of the historical institutional data 102. In embodiments, the prepared data set may be a more complete data set by including inferences or estimates for missing data. In creating the prepared data set, the statistical modeling engine 106 may also reformat or otherwise normalize the historical institutional data 102 into a format other than its native format. Normalization of the historical institutional data 102 may allow for easier or more efficient analysis of the data to generate programmatic milestones.

The prepared data set may then be analyzed to discover programmatic milestones. Programmatic milestones may be predictive indicators that historically indicate student success in completion of a particular course or major. Various different predictive indicators may be identified by the statistical modeling engine 106. A correlation may be identified between achieving a certain grade in a specific course and successfully completing a specific major. For example, students that received a B or better in the class MATH 3300 may be more likely to successfully complete a Theoretical Mathematics major. However, correlations between specific grades in courses and majors are only one type of predictive indicator that may be identified. Analysis of the prepared data set may also identify various skills that a student exhibits. Take, for example, four classes A, B, C, and D. The statistical modeling engine 106 may identify that students who took all four classes received similar grades in classes A, B, and C but a different grade in course D. The similar grades in courses A, B, and C may indicate that one or more particular skills are related to courses A, B, and C. Further analysis of classes A, B, and C may identify the one or more particular skills. For example, if classes A, B, and C are math classes, logical reasoning may be identified as a skill related to these classes. Upon identifying the skill, a student's grade in classes A, B, and C may be used to identify the student's ability with regard to the identified skill. In embodiments, skills may be further associated with successful completion of a particular course or major. For example, a correlation may be identified that students with an above average rating in logical reasoning may be more likely to pass a particular class or achieve a particular degree. While predictive indicators are herein described as including specific types of milestones (e.g., grades in particular classes) and skill sets, one of skill in the art will appreciate that different types of predictive indicators may be identified from historical or prepared data without departing from the scope of this disclosure. Other types of predictive indicators include, but are not limited to, students cumulative GPA, the number of credits completed by a student at a particular point in time, the involvement of the student in different activities, credit completion ratio, etc.

Upon identifying various predictive indicators, the statistical modeling engine 106 may produce data related to different programmatic milestones 108. The programmatic milestones may be a data set that includes the various predictive indicators used to predict success for particular courses or majors. The programmatic milestones 108 and current institutional data 104 may be provided as input to rules engine 110 and/or risk engine 112. Rules engine 110 may compare current institutional data 104 to the predictive indicators in the programmatic milestones 108 to estimate whether a student will successfully complete a particular course or major. Rules engine 110 may also identify alerts in response to events that indicate a student may be off track with respect to accomplishing a particular course or major. Risk score engine 112 may also receive programmatic milestones 108 and current institutional data 104 to generate predictive estimates with respect to the likelihood of a student successfully completing a particular major or completing a particular class.

In embodiments, the rules engine 110 and the risk score engine 112 generate predictive estimates that may be used to provide data useful to students, advisers, and school administrators. For example, predictive estimates may be programmatic alerts 114 that alert an adviser or student upon the occurrence of an event in the student's academic career that makes it less likely that the student will complete her major. Among other benefits, such alerts give the student and adviser indications as to whether a student will successfully complete a major. This helps the student and/or adviser take corrective actions at an earlier time thereby increasing the likelihood that the student will successfully graduate. The predictive estimates may also be used to provide a student risk profile 116. In embodiments, the student risk profile 116 may provide a student, adviser, or administrator with an overview of the obstacles a student faces with respect to completion of a specific major. Among other benefits, such information allows a student to proactively mitigate the risks in successful completion of a particular major or to change majors at an earlier point in time making it more likely that the student successfully completes a degree.

The predictive estimates may also be used to generate data related to major and course exploration 118. In embodiments, major and course exploration 118 may provide a student and/or administrator with an estimate on the likelihood of a student completing a particular course or major. For example, predictive estimates may be provided for various different majors. Students and advisers may use the predictive estimates to make an informed decision when choosing a particular major. Among other benefit, the informed decision will increase likelihood for completion since the student will choose a path better informed about their likelihood and potential risks. In additional embodiments, predictive estimates may be used to generate department reporting data 120. In embodiments, department reporting data 120 may include estimates on the current state of students enrolled in a particular school, major, or program. For example, an administrator may access department reporting data 120 to receive a snapshot of the number of students that are predicted to successfully complete their degree compared to the number of students in risk of degree completion. Among other benefits, this allows administrators to make informed decisions and better employ institutional resources to riskier areas to help maximize the number of students that successfully complete a major.

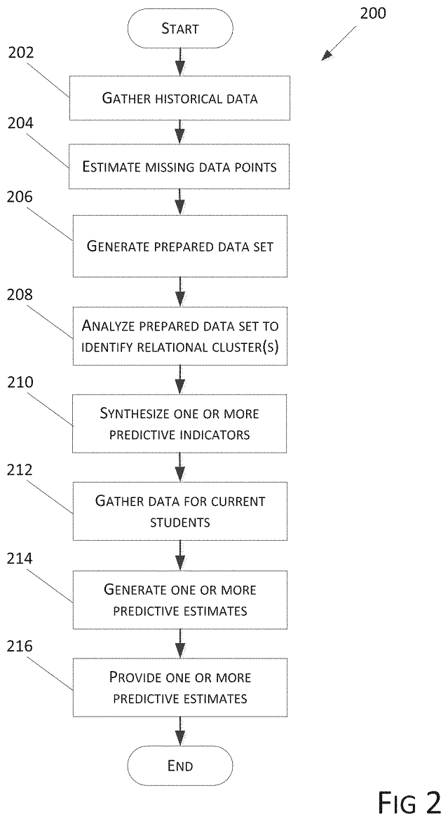

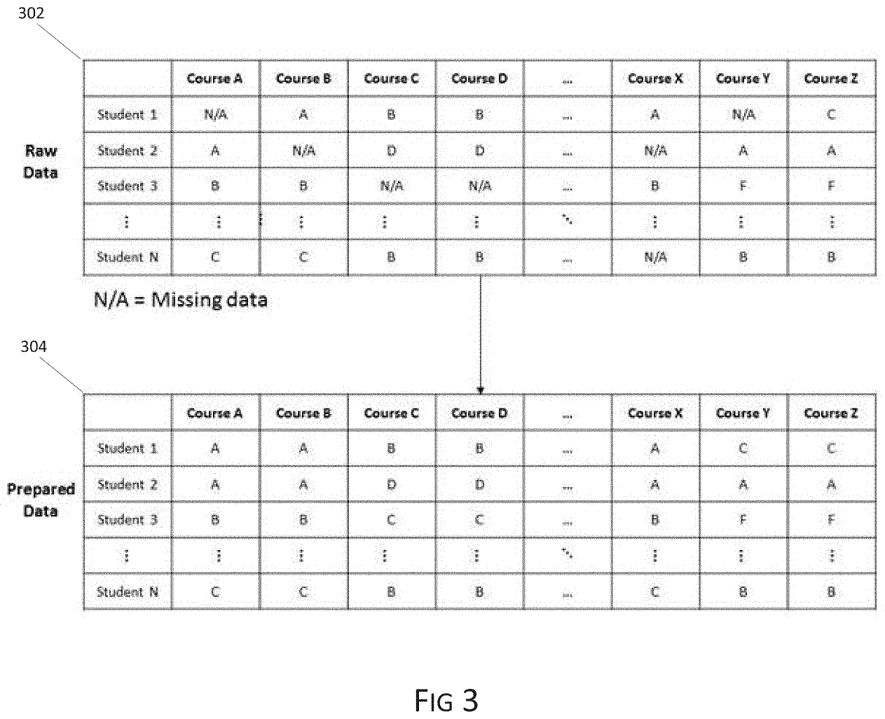

Having described an overview of embodiments of the student success collaboration systems disclosed herein, the disclosure will now describe the various embodiments of methods that may be employed to generate the predictive estimates and advisory data (e.g., programmatic alerts 114, student risk profile 116, major and course exploration 116, and department reporting data 120) described herein. FIG. 2 is an embodiment of a method 200 for providing predictive estimates related to an academic institution. Flow begins at operation 202 where historical data from an institution is received. In one embodiment, the historical data pertains to a single institution. Due to differences between academic institutions, predictive indicators identified for one institution may not be applicable to other institutions. Under such circumstances, historical information from a single institution may generate more reliable predictive indicators for that particular institution. However, in some circumstances, better predictive indicators may be generated using historical data from multiple institutions. As such, one of skill in the art will appreciate that the number of sources used to gather historical data may vary without departing from the spirit of this disclosure. As previously discussed, historical data may include information related to course grades, various clubs or teams individual students belong to, activities individual students participated in, awards or scholarships received by students, etc. As such, historical data can include any type of data that is useful in generating predictive indicators. In general, a larger historical data set may be used to generate better predictive indicators. As such, in embodiments, the method 200 may gather as much historical data as is available at operation 202. However, the amount of historical data gathered may be offset by efficiencies in processing the data. Briefly turning to FIG. 3, data set 302 is an exemplary embodiment of historical data that may be gathered at operation 202. For simplicity of explanation, embodiments disclosed herein are described with respect to historical data that includes grade data. In such embodiments, historical data set 302 includes grade data indicating the grades particular students received in particular courses. For example, as illustrated, student 1 received an A in Course B, a B in course C, a B in course D, etc. However, because students do not take all available classes offered by an academic institution, the historical data set 302 may be incomplete. For example, Student 1 did not take Course A or Course Y and as such, the historical data set 302 is missing data related to the Student 1's performance in those particular classes (indicated by the “N/A” entry in historical data set 302).

Returning to FIG. 2, after gathering historical data at operation 202, flow continues to operation 204 where missing data points from the historical data are inferred or otherwise estimated. In embodiments, a statistical analysis may be performed on the historical data set to estimate the missing data points at operation 202. One such example of statistical analysis may be identifying relationships between different classes and using the identified relationship to estimate a grade a student would have received in a class she did not take using the grade the student received in a related class. However, other forms of estimation may be performed at operation 202 without departing from the spirit of this disclosure. Upon estimating missing data points, flow continues to operation 206 where a prepared data set may be generated. The prepared data set may include the data points missing from the historical data set. In further embodiments, the prepared data set may also be formatted differently from the historical data set, such as, for example, optimizing the format for analysis. In embodiments, the prepared data set represents a more complete data set by including estimated data points for data missing in the historical data set. As such, the prepared data set may be used to better identify relational clusters and/or synthesize better predictive indicators. Turning again to FIG. 3, data set 304 is an exemplary prepared data set. As illustrated in prepared data set 304, the missing data from historical data set 302 has been replaced by estimated data points. For example, referring to Student 1, prepared data set 304 includes estimated data points for the missing data for Course A and Course Y from the historical data set 302. In the example, the missing data points were estimated by identifying relationships between classes. In the example, Course A and Course B are identified as being related. Similarly Course Y and Course Z are identified as related. Based on the identified relationships, missing data points for Courses A and Y for Student 1 were estimated by inferring that Student 1 would have received the same grade in Course A as she did in Course B and the same grade in Course Y as she did in Course Z. While a specific method for estimating data points is described with respect to FIG. 3, one of skill in the art will appreciate that the described exemplary method is for explanatory purposes and other methods of estimating missing data may be applied to generate the prepared data set 304 without departing from the spirit of this disclosure. In other embodiments, no prepared data set 304 is used, and only the raw data 302 is employed in method 200.

Referring back to FIG. 2, after generating the prepared data set flow continues to operation 208 where the prepared data set is analyzed to identify one or more relational clusters. In embodiments, a relational cluster may be the identification of specific data points as being related in a statistically significant way. Many different types of relational clusters may be identified at operation 208. One such relational cluster may be an identified milestone indicative in accomplishing a certain goal or task. A relationship may be identified between completion of a specific class and the successful completion of a major or successful completion of another class. Another type of relationship cluster may be a grouping of two or more classes as having a relationship. For example, a statistically significant number of students taking Course A, Course B, and Course C may have received similar grades in all three classes. As such, Courses A, B, and C may be identified as a relational cluster. While exemplary types of relational clusters and milestones have been described, one of skill in the art will appreciate that other types of relationships may be identified at operation 208.

After identifying relationships in the prepared data set, flow continues to operation 210 where predictive indicators are synthesized using the identified relationships. In embodiments, step 210 may make a determination as to why the relationships identified at operation 208 exist. Such determinations may be used to synthesize a predictive indicator. For example, a statistically significant number of students completing the course MATH 3300 with a grade of B or better may have successfully completed a degree in Theoretical Mathematics. As such, completion of MATH 3300 with a B or better grade may be identified as a predictive indicator as to the likelihood a student will successfully obtain a degree in Theoretical Mathematics. As another example, a relationship may be identified between Courses A, B, and C. Course A and B may be math classes and Course C may be a science class. Based upon this information, one or more skills may be identified as being applicable to courses A, B, and C. For example, because the courses are math and science classes, skills such as logical reasoning, mathematical aptitude, etc. may be synthesized based upon the relationship of the different classes. Such skill may be predictive indicators of a student's success in the related classes. Taking the example a step further, the skills may also be quantified based upon the grades students received in the related classes. For example, students who receive a C grade in the related courses may be identified as having an average ability in logical reasoning skill, while students who received A and B grades in the related courses be identified as having above average ability in the logical reasoning skill. The synthesized skills may then be used to draw correlations between the likelihood of success in completing a specific major or course. For example, a statistically significant number of students having above average ability in logical reasoning may successfully complete a specific course, such as, for example MATH 3300, or a specific majors, such as, for example, Theoretical Mathematics. As such, predictive indicators may be synthesized based on skill levels.

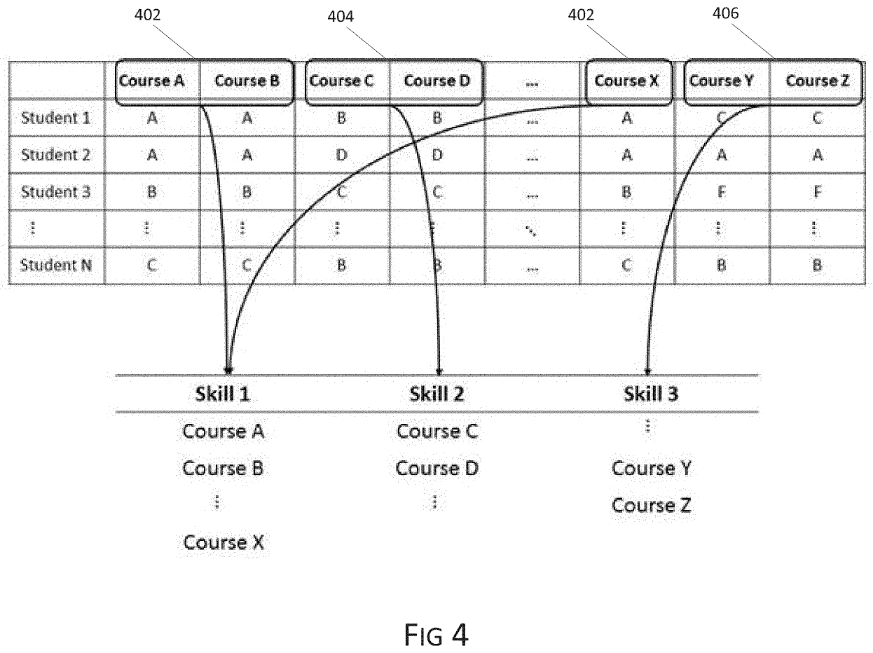

Turning briefly to FIG. 4, FIG. 4 illustrates an exemplary synthesis of predictive indicators. In the exemplary embodiment, three different relational clusters 402, 404, and 406 are identified. A first relationship 402 is identified between Courses A, B, and C. A second relationship 404 is identified between Courses C and D. Finally, a third relationship 406 is identified between Courses Y and Z. In embodiments, additional factors, such as data about the individual courses themselves, may be analyzed to synthesize one or more skills based upon the identified relational clusters. As illustrated in FIG. 4, three different skills, e.g., Skill 1 408, Skill 2 410, and Skill 3 412 are synthesized based upon the identified relational clusters 402, 404, and 406, respectively. The synthesis of skills provides more accurate predictive indicators than relying on grades alone. Skills may be better applied across different courses and subject matters. As such, defined skills can be applied to more courses as better predictors. For example, a determination that a student got an A in a Linear Algebra course may not be a strong indicator as to the student's performance in Physics 101, which does not incorporate linear algebra. However, a skill, such as logical reasoning, may be synthesized and quantified based on the student's performance in linear algebra. Logical reasoning is a skill that will likely influence the student's performance in Physics 101. As such, the synthesized skill may be used as a predictive indicator for classes which subject matter is unrelated.

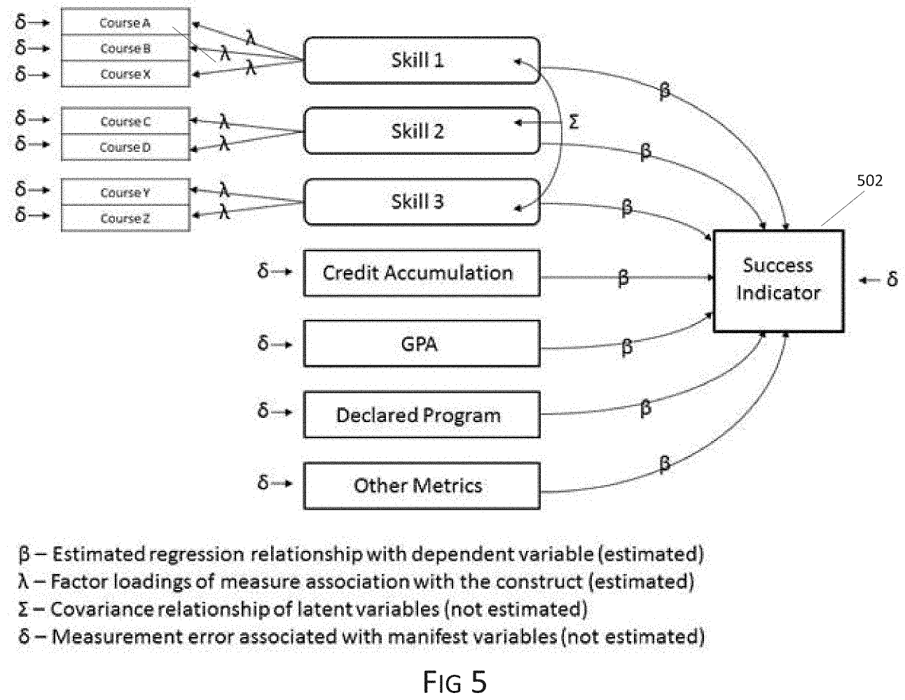

Returning to FIG. 2, the one or more predictive indicators may be stored and applied to current institutional data to generate predictive estimates as to the likelihood of success current students will have in completing a specific course or major. Flow continues to operation 212 where current institutional data is gathered. Current institutional data may include data about students currently attending the academic institution. Current institutional data may include information related to course grades, various clubs or teams individual students belong to, activities individual students participated in, awards or scholarships received by students, etc. The current institutional data may be input into a rules engine, a risk score engine, or the like and compared against predictive indicators to generate predictive estimate in operation 214. The predictive estimates may be generated automatically or in response to a specific query. In embodiments, different rules may be applied for generating predictive estimates. A different rule may be applied based upon a type of query received, the type of data accessible to a specific user, etc. Turning to FIG. 5, an exemplary process for generating a predictive estimate is illustrated. The illustrated embodiment depicts a success indicator 502 (e.g., a predictive estimate) derived from one or more skills (e.g., predictive indicators) synthesized from identified relational clusters. The one or more synthesized skills can be applied to current institutional data (e.g., credit accumulation, GPA, declared program, and/or other metrics) for one or more students based upon a rule (e.g., the exemplary regression relationship) to determine a success indicator for one or more courses or majors. In embodiments, the success indicator may be an estimate of the likelihood that a student will succeed in a particular course or major. The success indicator may be measured as a percentage (e.g., 92% chance of completion) or may be in the form of a discrete indicator (e.g., “Low,” “Medium,” or “High” chance of success). In alternate embodiments, the success indicator may be provided in terms of risk (e.g., 74% chance of failure or Low, Medium, High risk). One of skill in the art will appreciate that the success indicator, or predictive estimates, may be presented in various different forms without departing from the spirit of this disclosure.

Returning to FIG. 2, after determining one or more predictive estimates, flow continues to operation 216 where the one or more predictive estimates are provided. In embodiments, providing the one or more predictive estimates may include displaying the predictive estimates to a user via a graphical user interface, providing the one or more predictive estimates to another application for display to a user, including the one or more predictive estimates in a report, document, spreadsheet, etc., storing the one or more predictive estimates for later use, etc. Having described an exemplary process of generating predictive estimates based predictive indicators, the disclosure will now describe in further detail the processes involved in generating different types of predictive estimates.

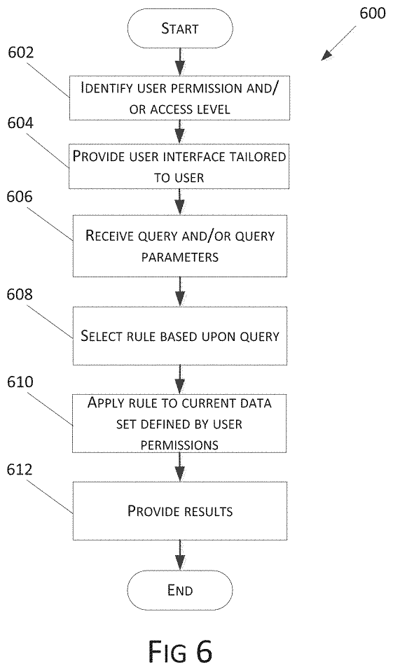

FIG. 6 is an embodiment of a method 600 for dynamically evaluating student performance against predictive indicators in real time and providing predictive estimates. Flow begins at operation 602 where a user permission and/or access level is identified for a user requesting to access institutional data or otherwise generate predictive estimates. In embodiments, different types of users may have access to different types of information and/or be able to perform different types of queries. For example, an individual student may only be able to access and query information about herself, an adviser may be able to access and query information about students assigned to the adviser, and an administrator may have access to all information for the institution. In embodiments, the identification performed in operation 602 may be based on a login credential or other type of identifying information known to the art. After identifying the permission and/or access level, flow continues to operation 604 where a user interface is provided tailored to the identified user. The user interface may be customized to include information relevant to the individual user and or include graphical user interface (GUI) components customized for the different functionality made available to the user based upon the user's permission level.

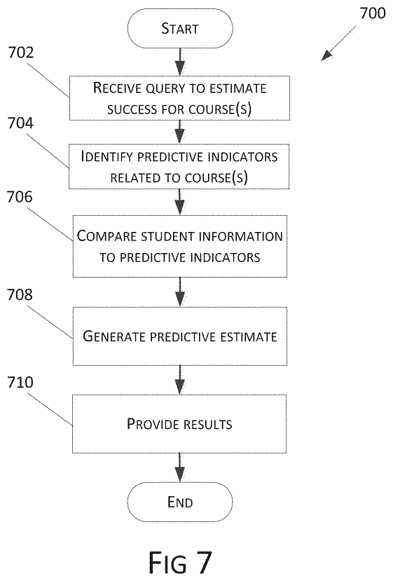

Flow continues to operation 606 where a query is received. In embodiments, the query may also include parameters to further define the query. An exemplary query may include a request for a predictive estimate regarding the likelihood of success that a particular student would have in a particular course or major. Exemplary parameters in such a query would include identification of the student and identification of one or more courses or majors. Upon receiving the query, flow continues to operation 608 where one or more rules are selected. The selected rule may be based upon the received query. In embodiments, a rule may be a process, method, or algorithm used to satisfy the requested query. Exemplary rules and the application of the exemplary rules are described in further details in the discussion of FIGS. 7-10. Flow continues to operation 610 where the selected rule is applied to a current data set. In embodiments, the current data set may be defined by the query, the user permission level, or a combination of both. For example, the current data set may be limited based upon the user's permission level. As such, a query by a student may be limited only to data about the relevant student. Data sets may also be defined by a query. For example, an administrator who has access to all student data may perform a query on a particular student, on a group of students (e.g., all Physics majors, all students in the School of Engineering, etc.). Under such circumstances, the data set to which the rule is applied is limited to the group defined by the query. After applying the rule, flow continues to operation 612 where the results of the executed query are provided. In embodiments, providing the results may include displaying the predictive estimates to a user via a graphical user interface, providing the one or more predictive estimates to another application for display to a user, including the one or more predictive estimates in a report, document, spreadsheet, etc., storing the one or more predictive estimates for later use, etc.

FIG. 7 is an embodiment of a method 700 for dynamically predicting course difficulty based on current and historical data. Flow begins at operation 702 where a query is received to estimate the success of a student (or students) in one or more courses. Flow continues to operation 704 where one or more predictive indicators for the one or more courses are identified. As previously described, a predictive indicator may be a milestone, a skill set, or any other type of indicator identified through analysis of historical institutional data. Flow continues to operation 706 where a data set of the current institutional information is compared to the one or more predictive indicators. Based upon the comparison, predictive estimates related to a student's success or risk with respect to the one or more courses are generated at operation 708. The predictive estimates may then be provided in operation 710. In embodiments, providing the one or more predictive estimates may include displaying the predictive estimates to a user via a graphical user interface, providing the one or more predictive estimates to another application for display to a user, including the one or more predictive estimates in a report, document, spreadsheet, etc., storing the one or more predictive estimates for later use, etc.

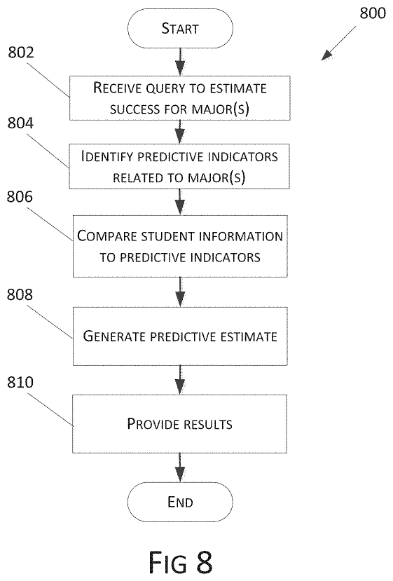

FIG. 8 is an embodiment of a method 800 for dynamically evaluating a predicted likelihood to complete any given major. Flow begins at operation 802 where a query is received to estimate the success of a student (or students) with respect to one or more majors. Flow continues to operation 804 where one or more predictive indicators for the one or more courses are identified. Flow continues to operation 706 where a data set of the current institutional information is compared to the one or more identified predictive indicators. Based upon the comparison, predictive estimates related to a student's success or risk with respect to the one or more majors are generated at operation 808. The predictive estimates may then be provided in operation 810. In embodiments, providing the one or more predictive estimates may include displaying the predictive estimates to a user via a graphical user interface, providing the one or more predictive estimates to another application for display to a user, including the one or more predictive estimates in a report, document, spreadsheet, etc., storing the one or more predictive estimates for later use, etc.

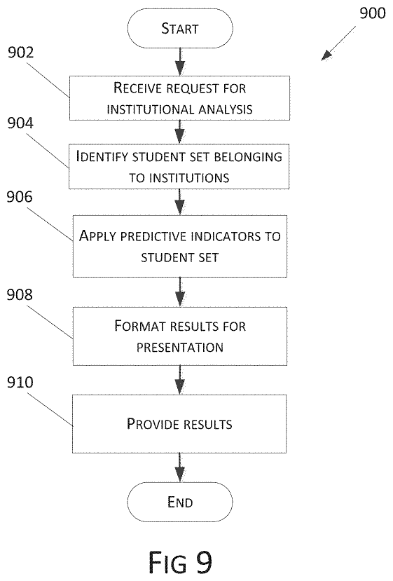

FIG. 9 is an embodiment of a method 900 for aggregating the predictive estimates at a program and institutional level. Flow begins at operation 902 where a request for an institutional analysis is received. A request for institutional analysis may be a request to query the current likelihood of success for students to complete a degree for students that are part of a specified institution. As used herein, an institution may be a particular college (e.g., the Business School, the Engineer School), a particular major, a particular program, or any other type of grouping or classification. Flow continues to operation 906 where students belonging to the institution are identified. In embodiments, the students may be identified in order to define the data set upon which to perform a predictive analysis. Flow continues to operation 906 where one or more predictive indicators are applied to the data set identified at operation 904. In embodiments, the one or more predictors applied at operation 906 may be selected based upon a query associated with the request received at operation 902. For example, the predictive indicators may apply to a particular course, major, etc. The application of the predictive indicators (e.g., comparing the defined data set to the predictive indicators) generates an indication of likelihood of success or risk level for the students that make up the selected institution. Because there may be a large number of students associated with the institution, flow continues to operation 908 where the results are formatted for presentation. For example, the results may be aggregated into a graph, displayed in a table, or provided as individual listings. One of skill in the art will appreciate any known method for formatting large amounts of data for presentation may be employed at operation 908. Flow then continues to operation 910 where the method 900 provides the results. In embodiments, providing the results may include displaying the predictive estimates to a user via a graphical user interface, providing the one or more predictive estimates to another application for display to a user, including the one or more predictive estimates in a report, document, spreadsheet, etc., storing the one or more predictive estimates for later use, etc.

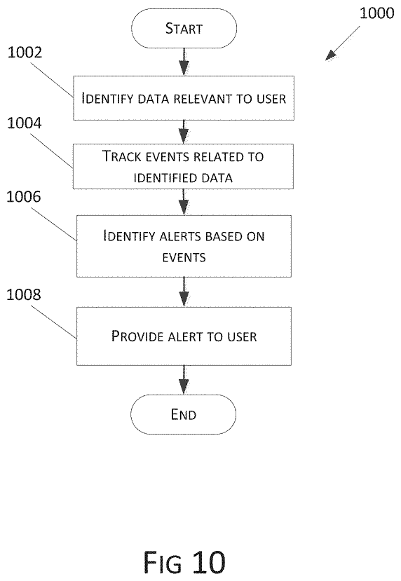

FIG. 10 is an embodiment of a method 1000 for generating alerts based upon predictive analysis of a student's success. Flow begins at operation 1002 where a determination is made as to what data is relevant to a user. For example, if the user is a student, the data relevant to the user is the student's data. If the user is an adviser, the data related to the user may be data related to all of the students assigned to the adviser. If the user is an administrator, the relevant data may be all information about an institution. In embodiments, a user may also indicate specific data that may be identified in operation 1002. For example, an administrator or adviser may indicate that they want to track the performance of a specific student. Under such circumstances, data related to the specific student may also be identified as related. Flow continues to operation 1004 where events associated with the relevant data are tracked. Tracking the events may include identifying changes or additions to the relevant data to identify the occurrence of an event. Upon identifying the event, flow continues to operation 1006 where a determination may be made as to whether or not the user should be alerted to the event. For example, the event may be compared to a predictive indicator. If the comparison results in an identified risk (e.g., a decrease in the likelihood of a student successfully completing a course or major) an alert may be identified for the user. Flow then continues to operation 1008 where the alert is provided to the user. In embodiments, providing the alert may include displaying the predictive estimates to a user via a graphical user interface, providing the one or more predictive estimates to another application for display to a user, including the one or more predictive estimates in a report, document, spreadsheet, etc., storing the one or more predictive estimates for later use, etc. In addition to providing other benefits, generating an alert for a user, such as an administrator or student, gives the user an early indication that the student may be off track in successfully completing a course or major. This gives the student the ability to take corrective action at an earlier date thereby increasing the student's chances of successfully completing a degree on schedule.

Having described various embodiments of methods that may be employed to synthesize predictive indicators and use the predictive indicators to generate predictive estimates as to the likelihood that a student will successfully complete a specific course or major, the disclosure will now describe various embodiments of user interfaces that may be employed by the systems and methods herein.

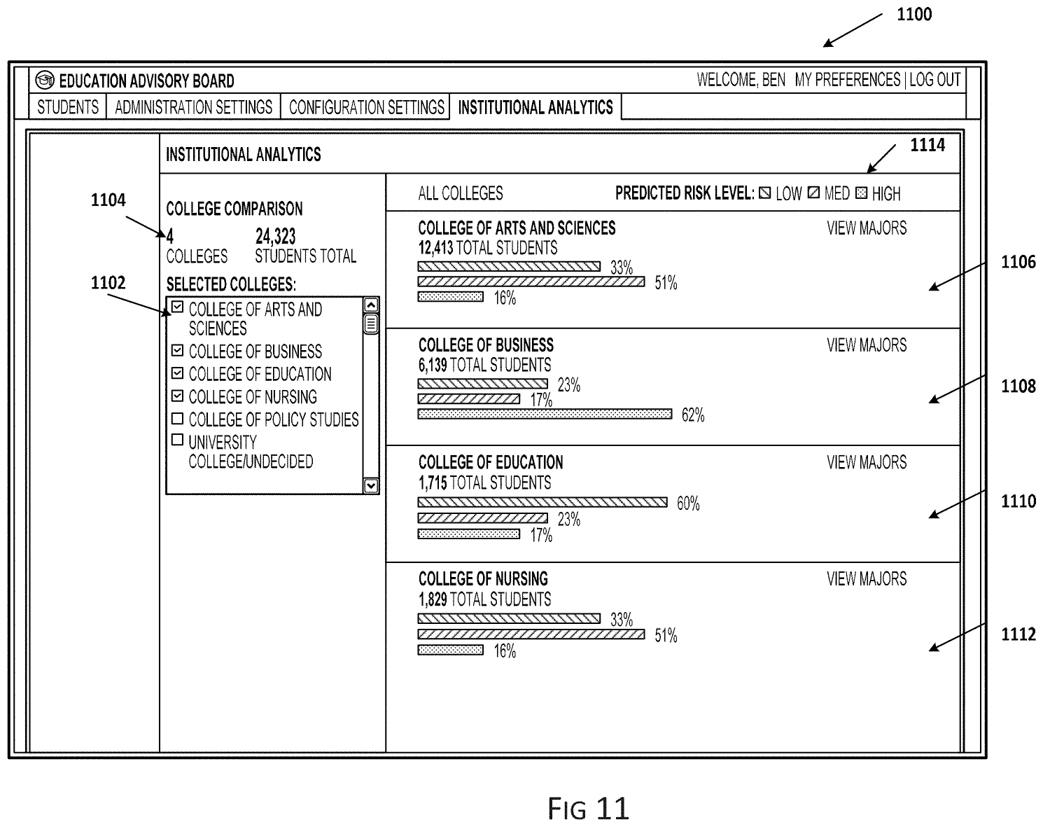

FIG. 11 is an embodiment of a user interface 1100 for displaying an institutional analysis. In embodiments, user interface 1100 may be displayed to an administrator, such as a provost, to display results generated by an institutional analysis. The user interface 1100 may also provide controls that a user can interact with to submit a query for an institutional analysis. In embodiments, the user interface 1100 may include a filter section 1102 providing interactive controls that a user can operate to define a data set for an institutional analysis query. These institutions may be used as parameters in a query for an institutional analysis. For example, in the depicted embodiment various check boxes are provided that a user can interact with to select specific institutions for the institutional analysis. For example, in the depicted embodiment, the a selection of the College of Arts and Sciences, College of Business, College of Educations, and College of Nursing are selected. The user interface 1100 contains a selection information section 1104 that displays information about the selected filters. For example, in the depicted embodiment, the selection information section 1104 identifies the number of colleges selected and the number of students included in the selected data set.

User interface 1100 may include one or more results sections 1106, 1108, 1110, and 1112. In embodiments, results generated by the institutional analysis may be displayed in the one or more results sections 1106, 1108, 1110, and 1112. As illustrated in FIG. 11 section 1106 displays the results for the College of Arts and Sciences, 1108 displays the results for the College of Business, 1110 displays the results for the College of Education, and 1112 displays the results for the College of Nursing. In the displayed embodiment, each of results sections 1106-1112 display information about the number of students that are part of the institution along with a graphical display indicating the likelihood of successfully completing a degree based on predictive estimates. More specifically, a bar graph is illustrated in each section displaying the number of students with low risk, medium risk, and high risk, as indicated by the key 1114. Each results section also includes an interactive component that allows a user view the majors associated with a college. For example, in the displayed embodiments, the interactive component is the text link “View Majors.”

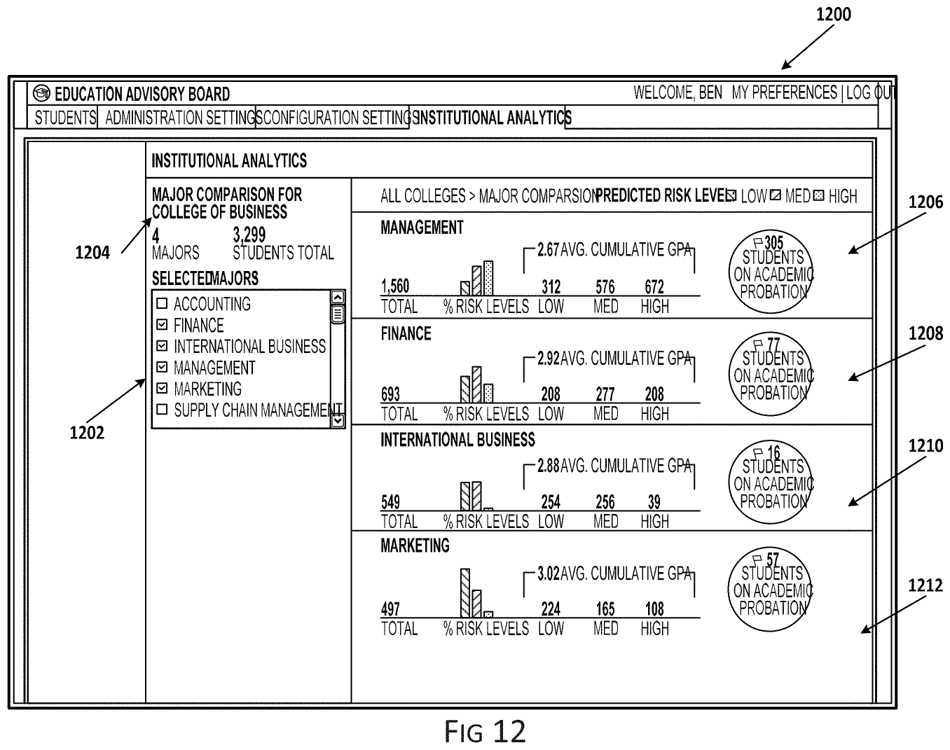

FIG. 12 is an embodiment of a user interface 1200 displaying an alternate view of an institutional analysis. In embodiments, user interface 1200 may be displayed to an administrator, such as a provost, to display results generated by an institutional analysis query. Specifically, user interface 1200 displays an institutional analysis of a single college (e.g., the College of Business) displaying the number of students at risk on a major by major bases. User interface 1200 may be displayed in response to a user interacting with the “View Majors” link displayed in FIG. 11. The user interface 1200 may also provide controls that a user can interact with to submit a query for an institutional analysis. In embodiments, the user interface 1200 may include a filter section 1202 providing interactive controls that a user can operate to define a data set for an institutional analysis query. For example, in the depicted embodiment various check boxes are provided that a user can interact with to select specific majors for the institutional analysis. These majors may be used as parameters in a query for an institutional analysis. For example, in the depicted embodiment, finance, international business, management, and marketing are selected. The user interface 1200 contains a selection information section 1204 that displays information about the selected filters. For example, in the depicted embodiment, the selection information section 1204 identifies the number of majors selected and the number of students included in the selected data set.

User interface 1200 may include one or more results sections 1206, 1208, 1210, and 1212. In embodiments, results generated by the institutional analysis may be displayed in the one or more results sections 1106, 1108, 1110, and 1112. As illustrated in FIG. 11 section 1106 displays the results for the management major, 1108 displays the results for the finance major, 1110 displays the results for the international business major, and 1112 displays the results for the marketing major. As depicted in user interface 1200, the results sections may be displayed in a specific order. For example, the results sections may be displayed based upon the number of high risk students for each major, the number of students on academic probation, as depicted in the illustrated embodiment, etc. In embodiments, each management section displays a vertical bar graph indicating the percentage of low, medium, and high risk students, a numerical display of the total number of students in each category, a display indicating the average cumulative GPA, and an indication of the number of students on academic probation for the particular major.

User interfaces 1100 and 1200 display embodiments of a user interface that may be generated in response to identifying a user as a school administrator. The exemplary embodiments provide examples of interfaces capable of receiving commands to perform an institutional analysis and displaying the results of such analysis. The depicted embodiments provide a tool that a school administrator may use to query and view up-to-date information that may be used in a decision making process to better help students successfully complete their degrees on time. While specific embodiments of a user interfaces for an administrator are provided, one of skill in the art will appreciate that different variations of user interface components may be practiced with the embodiments disclosed herein without departing from the scope of this disclosure.

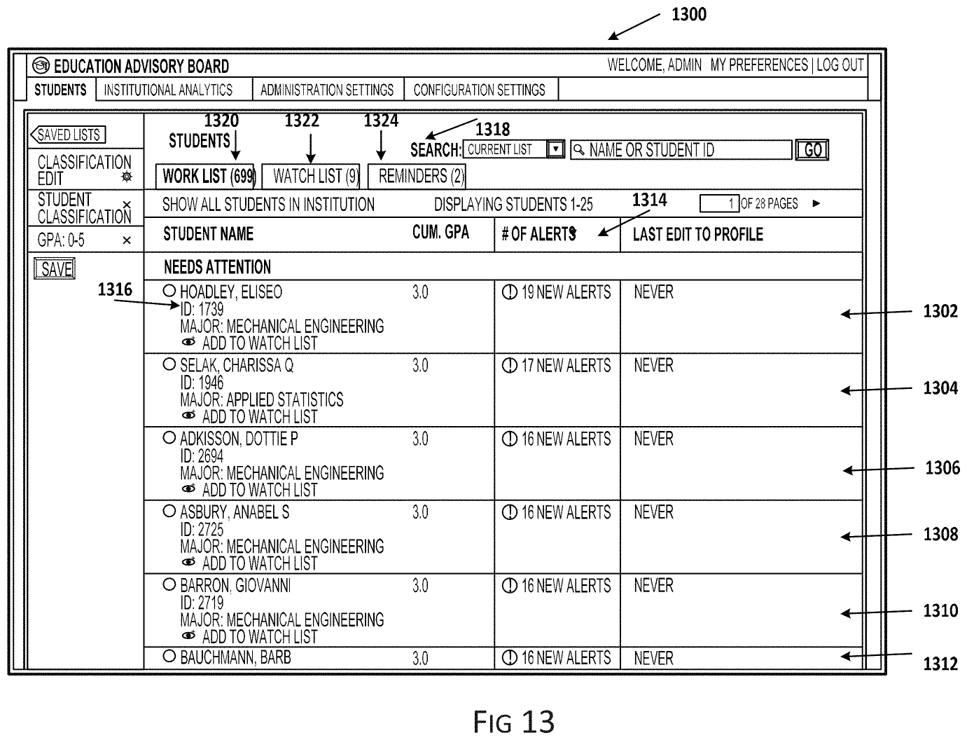

FIG. 13 is an embodiment of a user interface 1300 displaying a work list for an adviser. In embodiments, user interface 1300 may be displayed to a user identified as an adviser to display alerts and/or predictive estimates for one or more students. For example, the user interface 1300 may be employed to display alerts to a user, such as a school adviser, about students under the advisers watch. This provides the advisor with up-to-date information that she can use to quickly identify high risk students that may need additional aid to successfully complete a degree. User interface 1300 displays a work list that includes multiple student snapshot displays 1302, 1304, 1306, 1308, 1310, and 1312 of students that require assistance from an adviser. In embodiments, the student snapshots are ordered by the number of alerts generated by each student. In the depicted embodiment, the work list is ordered from high to low. However, user interface 1300 includes a filter 1314 element that a user can interact with to adjust the ordering or filter the results. In embodiments, student snapshots 1302, 1304, 1306, 1308, 1310, and 1312 provide high level information about a student. For example, in the depicted embodiment, each student snapshot 1302-1312 includes data fields displaying a student name, student ID, the student's major, the student's cumulative GPA, the number of alerts generated by predictive estimates for the student, and information related to the last time the student profile was updated. In embodiments, each student snapshot 1302-1312 may also contain an element 1316 that the user can interact with to add the student to a watch list. In embodiments, a user may add specific students to a watch list in order to keep closer track of the student.

As illustrated in user interface 1300 multiple views of data may be provided by selecting a number of tabs over the student snapshot section. For example, a “Work List” tab 1320, a “Watch List” tab 1322, and a “Reminders” tab 1324 are displayed. A user may select one of the “Work List” tab 1320, the “Watch List” tab 1322, or the “Reminders” tab 1324 to display a work list, watch list, or reminder information, respectively. In embodiments, user interface 1300 may also include a search component 1318. A user can interact with the search component 1318 to perform a text search for a specific student and/or other information in a work list, watch list, reminders, etc. In embodiments, the search component 1300 may include a text field which receives a search string as well as a drop down menu which displays different data sets (e.g., work list, watch list, etc.) to perform the search on.

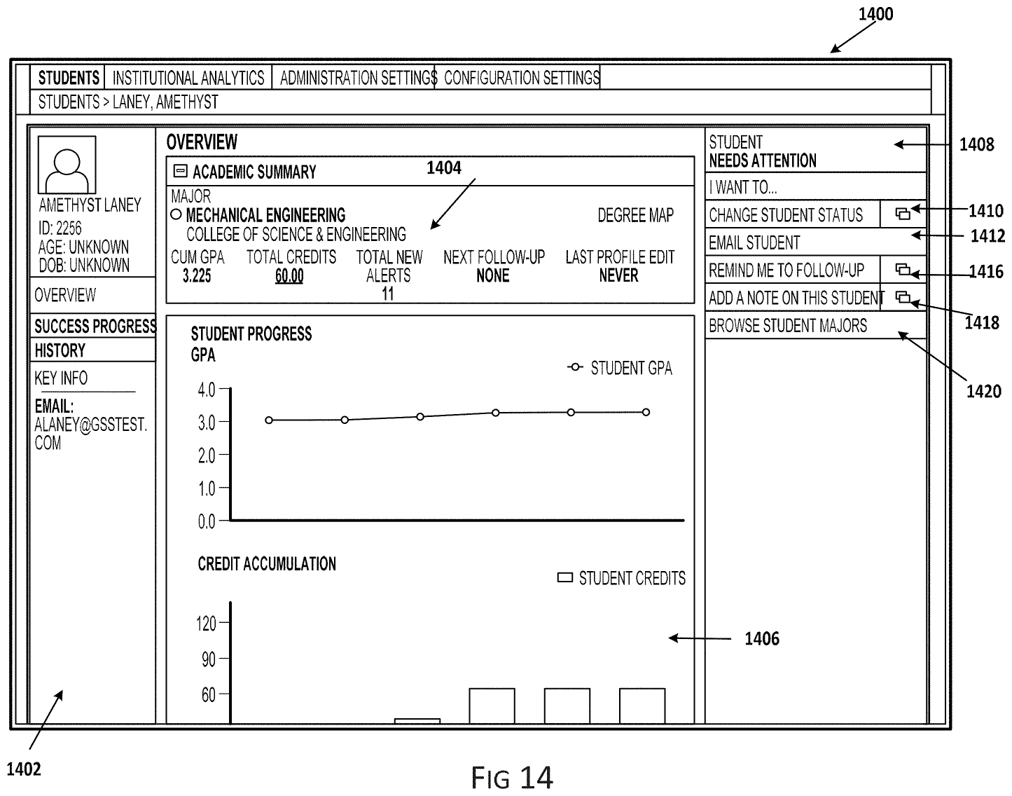

FIG. 14 is an embodiment of a user interface 1400 displaying information about a student. In embodiments, user interface 1400 may be displayed to a user identified as an specific student or may be displayed to an administrator who selects an individual student snapshot 1302-1312 as displayed in FIG. 13. User interface 1400 may include a student information section 1402 which displays information such as a picture of the student, the student name, student ID, student age and/or birthdate, student email address, phone number, mailing address. The student information section 1402 may include individual section elements that can be expanded when interacted with to display specific information. For example, student information section 1402 contains selectable section elements for an overview of the student, a success progress tracker for the student, and the student history. In embodiments, selection of one of these section elements may display the selected information in the user interface.

User interface 1400 includes a display section 1404 that displays information related to the selected section element. For example, in the depicted embodiment overview information is displayed in response to a selection of the overview selection element that is displayed in the student information section 1402. The overview information include information about the student's academic progress such as the student's major, the student's college, cumulative GPA, number of credits completed, number of alerts generated based on predictive estimates, scheduling information for the students next follow up meeting with an adviser, and/or the edit date of the student's profile. The display section 1404 may also include a graph display section 1406 that charts the students GPA and/or credit accumulation on a quarter by quarter, semester by semester, etc. basis.

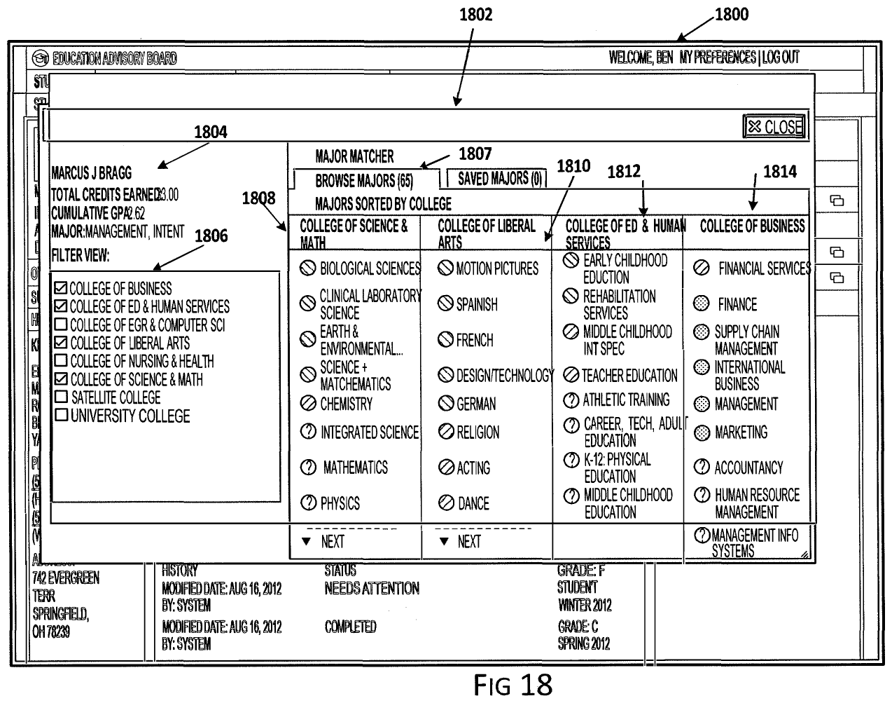

User interface 1400 may also include a status section 1408 that displays information regarding whether or not a student needs attention. Various controls may also be displayed that a user can interact with to change the student's status 1410, email the student 1412, set a reminder to follow up on the student 1416, add notes about the student 1418, and/or browse majors for the student 1418. The control to browse majors 1418 may display a major evaluation display as will be discussed in further detail with respect to FIG. 18.

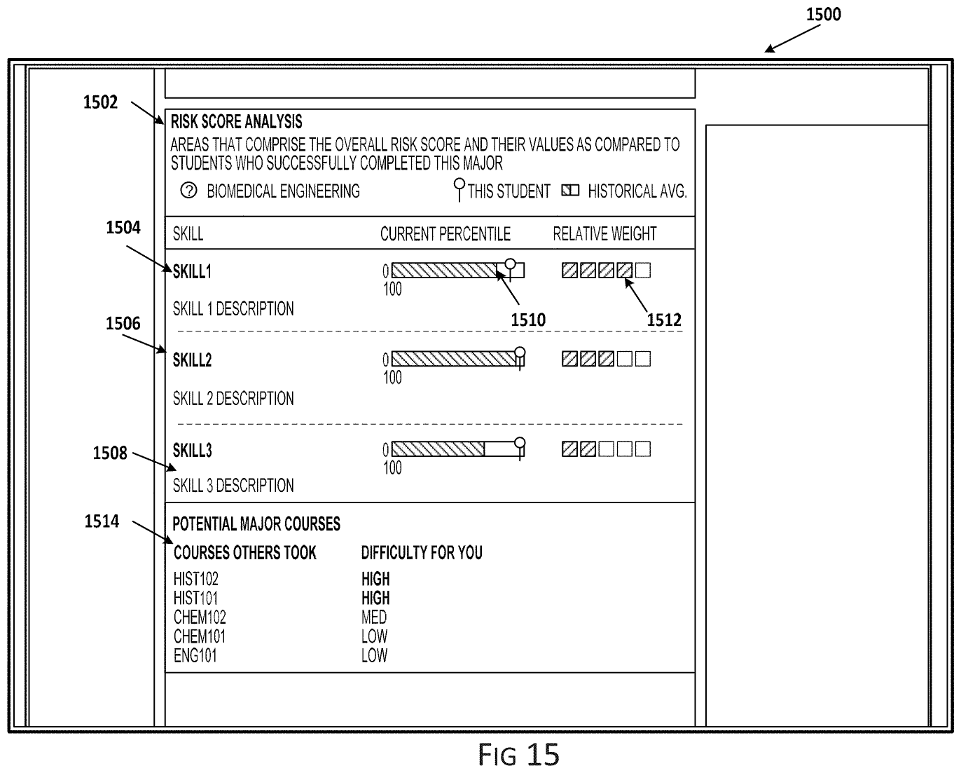

FIG. 15 is an embodiment of a user interface 1500 displaying a risk score analysis for a student. The user interface 1500 displays a risk analysis section 1502 that identifies the risks (e.g., likelihood of success) the student faces based upon predictive estimates. In embodiments, the risk analysis section 1502 displays various skill sections 1504 and 1506 that are indicative of successful completion of a selected major. In embodiments, the skills may be identified by analysis of a historical data set or a prepared data set. In embodiments, the skill sections 1504 and 1506 may display a bar graph 1510 comparing the student's performance in the identified skill as compared to the historical performance of students who successfully completed a major. The student's performance may be determined by evaluation of current institutional data for the student. The skill sections 1504, 1506, and 1508 may also include a weight indicator 1512 that displays the relative weight. Risk analysis section 1502 may also include a course prediction section 1514 that indicates potential courses the student may take based on courses other students with the same major have previously taken. The course prediction section 1514 may also provide predictive estimates about the difficulty the student may have in completing each course (e.g., high, medium, low, unknown). One of skill in the art will appreciate that additional factors may also be employed to generate a risk score analysis. Such factors may also be displayed in FIG. 15.

User interface 1500 provides a display that a student or academic adviser can review in order to make an informed decision about the likelihood that the student will successfully complete her chosen major. Predictive estimates are displayed that will allow the student or adviser to make an educated determination as to whether the student will be able to successfully complete required courses prior to the student taking the courses. This allows the student to decide whether she can perform the tasks required to graduate before she finds herself failing a required class which may prohibit the student from graduating on time or even graduating at all.

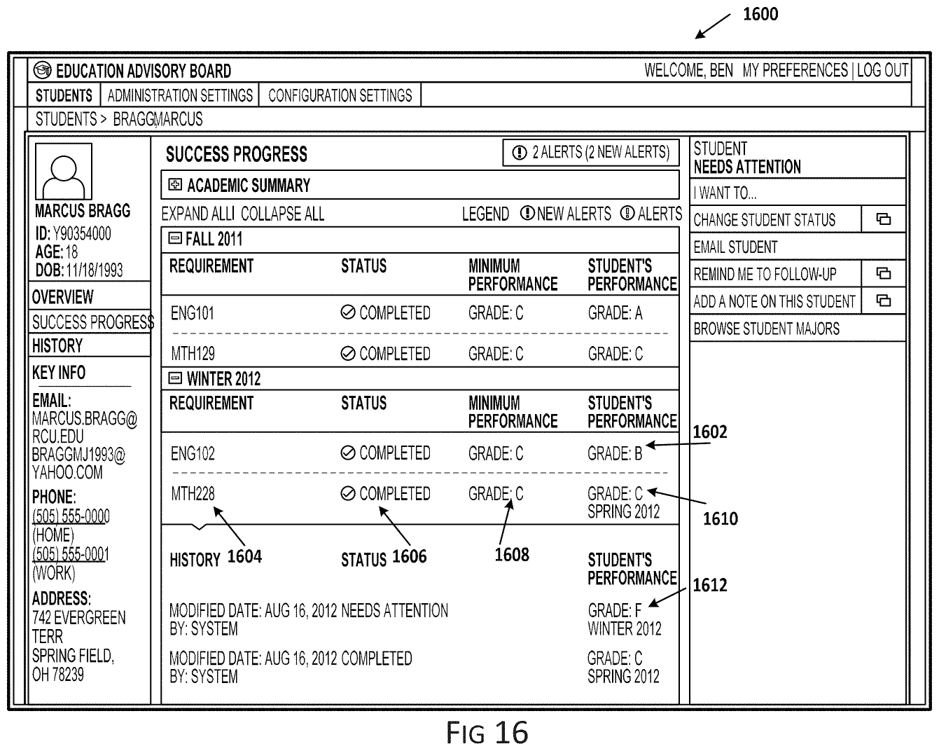

FIG. 16 is an embodiment of a user interface 1600 displaying success tracking information for a student. User interface 1600 may be displayed in response to a selection to view data related to the successful completion of required courses for a major. In embodiments, various course sections, such as course sections 1602 and 1612, display required courses taken by the student. Each course section includes a course identifier 1604, a status identifier 1606 (e.g., completed, needs attention, in progress), a minimum performance requirement 1608, and the student's performance 1610. In embodiments, the minimum performance requirement is determined based on analysis of historical and/or prepared data to determine what the minimum performance in a required class is for a student to have a high probability of successfully obtaining a degree (e.g., a predictive indicator). User interface 1600 may also provide an alert for a specific course as illustrated in course section 1612 that draws attention to any areas where the student's performance does not meet the required predictive indicator. As such, user interface 1600 provides a display that allows a student or adviser to track the student's progress against predictive indicators, thereby facilitating the ability of the student to track her progress and ensure she is on a path to successfully completing her degree.

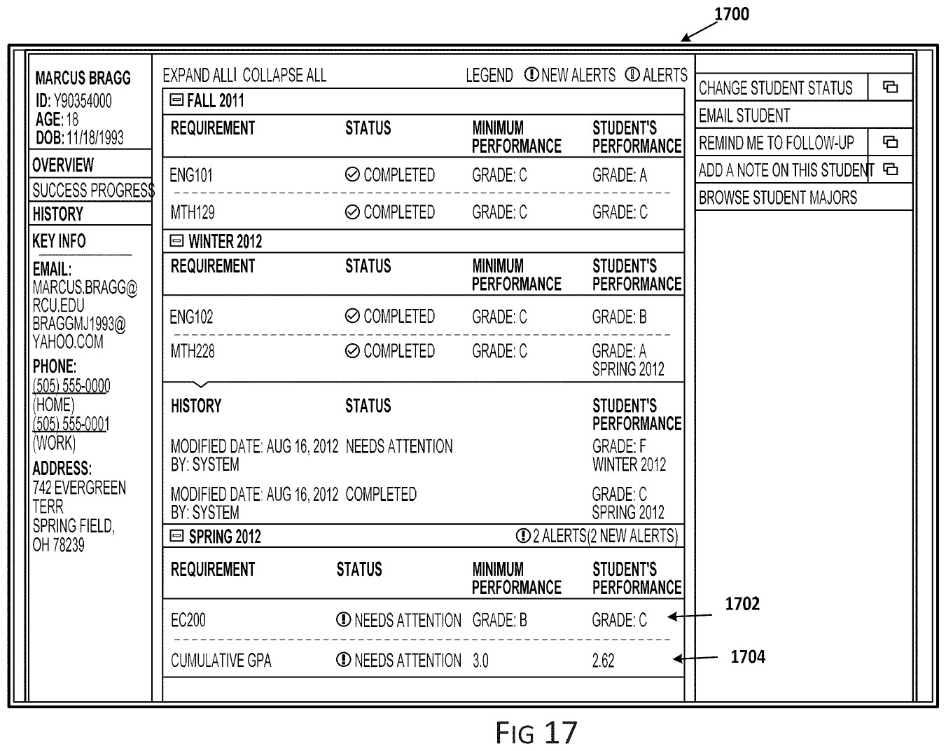

FIG. 17 is an embodiment of a user interface 1700 displaying an alternate view of course alerts for a student. The user interface 1700 displays alerts 1702 and 1704 that draws attention to student performance that does not meet predictive indicators for the student's selected major. For example, alert 1702 may be generated because the student received a C in the course EC200. The predictive indicator for EC200 shows that a minimum performance of a B in the course EC200 indicates successful completion of the student's major. As previously discussed, predictive indicators may be based on information other than grades in a particular course. Alert 1704 may be generated due to the fact that the student's GPA of 2.62 does not meet the predictive indicator of a 3.0 GPA. User interface 1700 provides means for displaying predictive indicators and estimates to a student that allows the student to identify whether she is on track to graduate before she faces obstacles that may prohibit her from graduating.

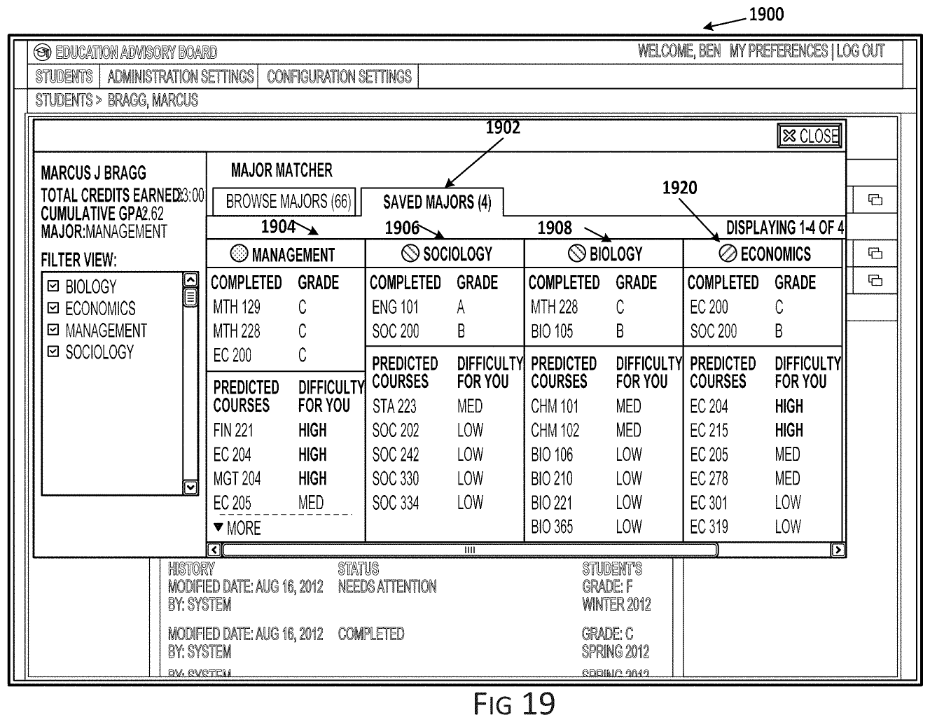

FIG. 18 is an embodiment of a user interface 1800 displaying a major matcher. In the recited embodiment, a major matcher display 1802 may be displayed as an overlay to another user interface window. In embodiments, the major matcher display 1802 may include a student information section 1804 listing data about a student such as the student's name, credit accumulation, cumulative GPA, and selected major. Major matcher display 1802 may also include a filter 1806 which allows the user to pick particular institutions or programs. The majors of the selected institutions may be used in a predictive estimate query. In the illustrated example, the College of Business, College of ED & Human Services, College of Liberal Arts, and College of Science and Math are selected. As such, in the illustrated embodiments, predictive estimates for majors from the selected colleges may be generated for the particular student. The predictive estimates are displayed in one or more predictive estimate sections 1808, 1810, 1812, and 1814. The predictive estimate sections 1808, 1810, 1812, and 1814 may be displayed side by side to allow easy comparison of the predictive estimates. In embodiments, the ordering of the predictive estimate sections 1808, 1810, 1812, and 1814 may be influenced based on the number of majors each institution has that the student will likely succeed in. In other embodiment, ordering may be based on other determinations such as, for example, the number of high risk majors for the student. In embodiments, each predictive estimate sections 1808, 1810, 1812, and 1814 may display predictive estimates of the student's performance in particular majors for the selected institution. The particular majors may be ordered based on the likelihood of success, degree of risk, etc. The predictive estimate sections 1808, 1810, 1812, and 1814 may be displayed in response to a selection of the “Browse Majors” tab. As will be illustrated in further detail in FIG. 19, the user may select multiple majors to view additional information and predictive estimates about each major. As such, user interface 1800 displays predictive estimates that a student may use to make an informed decision when selecting a major based on the likelihood that she will successfully complete the major.

FIG. 19 is an embodiment of a user interface 1900 displaying an alternate view of a major matcher that provides course level detail for selected majors. User interface 1900 may be displayed in response to a selection of the “Saved Majors” tab. Majors may be selected from the majors displayed in the major matcher 1802 from FIG. 18. In embodiments, various major analysis sections 1904, 1906, and 1908 may be displayed side by side to allow comparison of the different majors. A major analysis section may include information about required major courses that the student has already completed along with the grade the student received in the course. Major analysis sections 1904, 1906, and 1908 may also include predictive estimates for required courses that the student has not yet taken. The predictive estimates may display a degree of difficulty (e.g., high, medium, or low), risk, or likelihood of success that the student will have for each class based on comparisons of the student's information against one or more predictive indicators. In further embodiments, additional information such as, but not limited to, career and/or employment data or outcomes for a particular major may also be presented as part of the user interface 1900. As such, the user interface 1900 provides students with a tool that they can use to make informed decisions when picking a major. Using the tool, students can select majors that they will have the best chance of succeeding in.

While various embodiments of user interfaces have been disclosed herein, on of skill in the art will appreciate that the described user interfaces are provided as examples only. Variations of user interface elements, such as ordering information differently, use of different UI elements (e.g., drop down boxes, radio buttons, etc.) may be employed in other embodiments of user interfaces without departing from the scope of this disclosure.

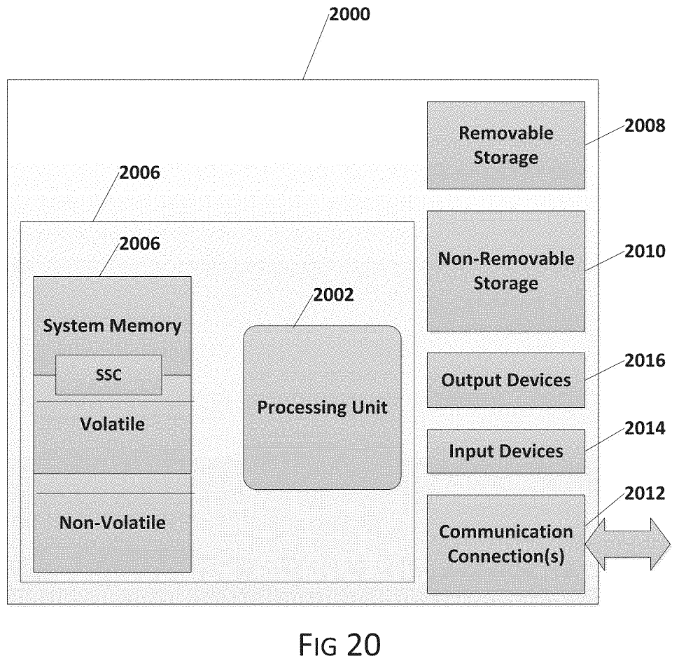

FIG. 20 illustrates one example of a suitable operating environment 2000 in which one or more of the present embodiments can be implemented. This is only one example of a suitable operating environment and is not intended to suggest any limitation as to the scope of use or functionality. Other well-known computing systems, environments, and/or configurations that can be suitable for use include, but are not limited to, personal computers, server computers, hand-held or laptop devices, multiprocessor systems, microprocessor-based systems, programmable consumer electronics such as smart phones, network PCs, minicomputers, mainframe computers, smartphones, tablets, distributed computing environments that include any of the above systems or devices, and the like.

In its most basic configuration, operating environment 2000 typically includes at least one processing unit 2002 and memory 2004. Depending on the exact configuration and type of computing device, memory 2004 (storing, among other things, instructions to implement and/or perform the modules and methods disclosed herein) can be volatile (such as RAM), non-volatile (such as ROM, flash memory, etc.), or some combination of the two. This most basic configuration is illustrated in FIG. 20 by dashed line 2006. Further, environment 2000 can also include storage devices (removable, 2008, and/or non-removable, 2010) including, but not limited to, magnetic or optical disks or tape. Similarly, environment 2000 can also have input device(s) 2014 such as touch screens, keyboard, mouse, pen, voice input, etc. and/or output device(s) 2016 such as a display, speakers, printer, etc. Also included in the environment can be one or more communication connections, 2012, such as LAN, WAN, point to point, Bluetooth, RF, etc.

Operating environment 2000 typically includes at least some form of computer readable media. Computer readable media can be any available media that can be accessed by processing unit 2002 or other devices comprising the operating environment. By way of example, and not limitation, computer readable media can comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, solid state storage, or any other medium that does not include a propagated data signal and can be used to store the desired information. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 2000 can be a single computer operating in a networked environment using logical connections to one or more remote computers. The remote computer can be a personal computer, a server, a router, a network PC, a peer device or other common network node, and typically includes many or all of the elements described above as well as others not so mentioned. The logical connections can include any method supported by available communications media. Such networking environments are commonplace in offices, enterprise-wide computer networks, intranets and the Internet.

In some embodiments, the components described herein comprise such modules or instructions executable by computer system 2000 that can be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some embodiments, computer system 2000 is part of a network that stores data in remote storage media for use by the computer system 2000.

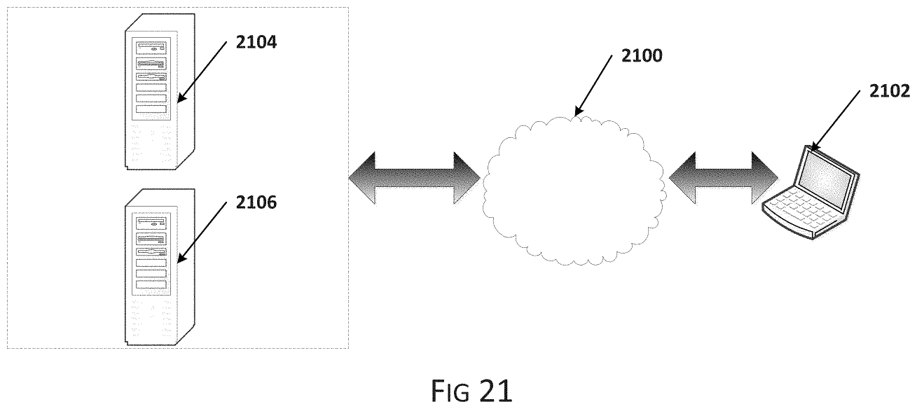

FIG. 21 is an embodiment of a network 2100 in which the various systems and methods disclosed herein may operate. In embodiments, a client device, such as client device 2102, may communicate with one or more servers, such as servers 2104 and 2106, via a network 2108. In embodiments, a client device may be a laptop, a personal computer, a smart phone, a PDA, a netbook, or any other type of computing device, such as the computing device in FIG. 1. In embodiments, servers 2104 and 2106 may be any type of computing device, such as the computing device illustrated in FIG. 1. Network 208 may be any type of network capable of facilitating communications between the client device and one or more servers 2104 and 2106. Examples of such networks include, but are not limited to, LANs, WANs, cellular networks, and/or the Internet.

In embodiments, the various systems and methods disclosed herein may be performed by one or more server devices. For example, in one embodiment, a single server, such as server 2104 may be employed to perform the systems and methods disclosed herein. Client device 2102 may interact with server 2104 via network 2108 in order to access information such as, the historical information, course information, student information, grades, etc., or any other object, property, and/or functionality disclosed herein. In further embodiments, the client device 2106 may also perform functionality disclosed herein.

In alternate embodiments, the methods and systems disclosed herein may be performed using a distributed computing network, or a cloud network. In such embodiments, the methods and systems disclosed herein may be performed by two or more servers, such as servers 2104 and 2106. As such, one of skill in the art will appreciate that the embodiments disclosed herein may be implemented as software as a service (SaaS) where software may be hosted centrally on a cloud network comprised of multiple devices. Although a particular network embodiment is disclosed herein, one of skill in the art will appreciate that the systems and methods disclosed herein may be performed using other types of networks and/or network configurations.

The embodiments described herein can be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices can be employed to perform the functionality disclosed herein without departing from the scope of the disclosure.

This disclosure described some embodiments of the present disclosure with reference to the accompanying drawings, in which only some of the possible embodiments were shown. Other aspects can, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments were described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A computer-implemented method for generating and displaying a predictive analysis, the method comprising:
receiving, using at least one processor, prior event data, the prior event data comprising a plurality of fields, the plurality of fields corresponding to a plurality of columns and a plurality of rows;
determining, using the at least one processor, column field value correlations between the plurality of fields in the plurality of columns;
determining, using the at least one processor, a first column of the plurality of columns with a column field value correlation beyond a predetermined threshold with a second column of the plurality of columns;
determining and filling in, using the at least one processor, at least one missing field value of the plurality of fields in the first column based on at least one completed field value of a corresponding row in the second column to generate infilled prior event data;
determining, using the at least one processor, whether any of the infilled prior event data is not in a predetermined format;
in response to determining that the infilled prior event data is not in a predetermined format, normalizing, using the at least one processor, the infilled prior event data in accordance with the predetermined format to generate a prepared prior event data set;
determining, using the at least one processor, a plurality of relational clusters, using the prepared prior event data set, each relational cluster corresponding to a plurality of related columns of the plurality of columns, wherein the related columns in each cluster of the plurality of relational clusters are associated with a column field value correlation beyond the predetermined threshold;
receiving, using the at least one processor, a request for a risk analysis for an individual;
receiving, using the at least one processor, user event data associated with the individual;
determining, using the at least one processor, based on a relationship between the user event data and at least one of the plurality of relational clusters, the risk analysis for the individual; and
after a predetermined period of time or after a predetermined event, determining, using the at least one processor, an updated risk analysis for the individual, wherein the risk analysis and updated risk analysis comprise a rating of the individual for at least one indicator, the at least one indicator being determined based on at least one of the plurality of relational clusters.

2. The method of claim 1, wherein the risk analysis determines a likelihood that the individual will succeed in a course or major of interest being beyond a predetermined threshold.

3. The method of claim 1, wherein determining the risk analysis for an individual further comprises:
determining, using the at least one processor, a plurality of relationships, each relationship of the plurality of relationships being estimated based on the user event data and one of the plurality of relational clusters; and
determining, using the at least one processor, the risk analysis based on the plurality of relationships.

4. The method of claim 1, further comprising:
iteratively performing, using the at least one processor, the risk analysis for a plurality of students; and
using the risk analysis for the plurality of individuals, predicting a portion of the students that will graduate.

5. The method of claim 1, wherein determining the risk analysis for the individual further comprises:
determining, using the at least one processor, based on a covariance relationship of latent variables associated with a plurality of relational clusters, the risk analysis for the individual.

6. The method of claim 1, further comprising:
determining, using the risk analysis, a predictive indicator of successful completion of a course or major of interest by identifying students in the prepared prior event data set who completed the course or major of interest and identifying one or more grades associated with those students in the prepared prior event data set.

7. The method of claim 1, further comprising:
while iteratively determining, using the at least one processor, the risk analysis for the individual, determining whether the risk analysis for the individual has fallen below a predetermined threshold; and
upon determining that the risk analysis for the individual has fallen below the predetermined threshold, generating and providing an alert to one or more users.

8. The method of claim 1, wherein each column in the plurality of columns corresponds to an educational course, and each row in the plurality of rows corresponds to an individual student, and each field of the plurality of fields corresponds to a grade or score.

9. The method of claim 1, wherein the risk analysis comprises one or more of:
a rating of the individual for the at least one indicator as compared with students in the prepared prior event data set;
a weight of the at least one indicator paired with students in the prepared prior event data set, wherein the weight identifies a strength of a correlation of the at least one indicator to successful completion of an educational course or educational major of interest; and
a weight of one or more grades in the prepared prior event data set, wherein the weight identifies a strength of a correlation of the one or more grades in the prepared prior event data set to the successful completion of the course or major of interest.

10. The method of claim 1, wherein each column in the plurality of columns corresponds to an educational course, and each row in the plurality of rows corresponds to an individual student, and each field of the plurality of fields corresponds to a grade or score.

11. The method of claim 1, wherein a user provides the request for risk analysis, the user comprising one of:
a student;
an adviser; and
an administrator.

12. The method of claim 1, wherein the risk analysis for the individual comprises a recommended educational major for the individual.

13. The method of claim 1, wherein determining a plurality of relational clusters using the prepared prior event data set comprises:
identifying, using the at least one processor, two or more similar grades listed for a student in the prepared prior event data set; and
identifying, using the at least one processor, courses associated with the two or more similar grades.

14. The method of claim 1, wherein the risk analysis for the individual comprises a recommended educational major for the individual.

15. A system for generating and displaying a predictive analysis, the system including:
at least one data storage device that stores instructions for generating and displaying a predictive analysis; and
at least one processor configured to execute the instructions to perform operations comprising:
receiving prior event data, the prior event data comprising a plurality of fields, the plurality of fields corresponding to a plurality of columns and a plurality of rows;
determining column field value correlations between the plurality of fields in the plurality of columns;
determining a first column of the plurality of columns with a column field value correlation beyond a predetermined threshold with a second column of the plurality of columns;
determining and filling in at least one missing field value of the plurality of fields in the first column based on at least one completed field value of a corresponding row in the second column to generate infilled prior event data;
determining whether any of the infilled prior event data is not in a predetermined format;
in response to determining that the infilled prior event data is not in a predetermined format, normalizing the infilled prior event data in accordance with the predetermined format to generate a prepared prior event data set;
determining a plurality of relational clusters, using the prepared prior event data set, each relational cluster corresponding to a plurality of related columns of the plurality of columns, wherein the related columns in each cluster of the plurality of relational clusters are associated with a column field value correlation beyond the predetermined threshold;
receiving a request for a risk analysis for an individual;
receiving user event data associated with the individual;
determining, based on a relationship between the user event data and at least one of the plurality of relational clusters, the risk analysis for the individual; and
after a predetermined period of time or after a predetermined event, determining an updated risk analysis for the individual, wherein the risk analysis and updated risk analysis comprise a rating of the individual for at least one indicator, the at least one indicator being determined based on at least one of the plurality of relational clusters.

16. A non-transitory computer-readable medium storing instructions that, when executed by a computer, cause the computer to perform operations for generating and displaying a predictive analysis, the operations comprising:
receiving prior event data, the prior event data comprising a plurality of fields, the plurality of fields corresponding to a plurality of columns and a plurality of rows;
determining column field value correlations between the plurality of fields in the plurality of columns;
determining a first column of the plurality of columns with a column field value correlation beyond a predetermined threshold with a second column of the plurality of columns;
determining and filling in at least one missing field value of the plurality of fields in the first column based on at least one completed field value of a corresponding row in the second column to generate infilled prior event data;
determining whether any of the infilled prior event data is not in a predetermined format;
in response to determining that the infilled prior event data is not in a predetermined format, normalizing the infilled prior event data in accordance with the predetermined format to generate a prepared prior event data set;
determining a plurality of relational clusters, using the prepared prior event data set, each relational cluster corresponding to a plurality of related columns of the plurality of columns, wherein the related columns in each cluster of the plurality of relational clusters are associated with a column field value correlation beyond the predetermined threshold;
receiving a request for a risk analysis for an individual;
receiving user event data associated with the individual;
determining, based on a relationship between the user event data and at least one of the plurality of relational clusters, the risk analysis for the individual; and
after a predetermined period of time or after a predetermined event, determining, using the at least one processor, an updated risk analysis for the individual, wherein the risk analysis and updated risk analysis comprise a rating of the individual for at least one skill, the at least one skill being determined based on at least one of the plurality of relational clusters.
